(19) United States
(12) Patent Application Publication
(10) Pub. No.: US 2021/0187894 A1
(43) Pub. Date: Jun. 24, 2021

(54) Storage box having fireproof and heat-insulating functions

(71) Applicant: Shenzhen Yihuaxing Technology Co., Ltd., Shenzhen (CN)

(72) Inventor: Yuming Liu, Lianyuan (CN)

(21) Appl. No.: 17/195,503

(22) Filed: Mar. 8, 2021

(30) Foreign Application Priority Data
Jul. 15, 2020 (CN) 202010682202.4

(51) Int. Cl. B32B 1/00; A45C 11/00; B32B 5/02; B32B 5/26; B32B 9/04; B32B 19/08; B32B 19/06; B32B 17/02

(52) U.S. Cl. CPC B32B 1/00; B32B 2262/0261; B32B 5/02; B32B 5/26; B32B 9/047; B32B 19/08; B32B 19/06; B32B 17/02; B32B 2307/304; B32B 2307/3065; B32B 2439/46; B32B 2262/101; B32B 2262/103; B32B 2262/105; B32B 2262/12; A45C 11/00

(57) ABSTRACT

The present disclosure relates to the field of storage bags, and discloses a fireproof, explosion-proof and heat-insulating storage bag, including a storage bag body, where the storage bag body is composed of a first fireproof fabric, a heat insulation material, an auxiliary molding material, and a second fireproof fabric. In the present disclosure, different specifications of models are formed by a fireproof and explosion-proof material, the heat insulation material and an auxiliary molding material; a plurality of materials are integrated to achieve fireproof, explosion-proof and heat-insulating functions, so that it is ensured that the product cannot be damaged within a certain period of time when placed on a fire source, and no spontaneous combustion occurs inside the storage bag. The fire source leakage is prevented, the fire source is prevented in the storage bag, and no fire is caused, thereby achieving the fireproof, explosion-proof and heat-insulating functions.

### TECHNICAL FIELD

The present disclosure relates to the technical field of storage bags, and in particular, to a fireproof, explosion-proof and heat-insulating storage bag.

### BACKGROUND

A battery refers to a part of a space of a cup, a groove or another container or a composite container that contains an electrolyte solution and a metal electrode to generate a current, and can convert chemical energy into electric energy. The battery has a positive electrode and a negative electrode. With the advancement of technology, batteries generally refer to small devices that can generate electric energy.

The batteries in all walks of life have brought much convenience to everyone's life, but battery products are flammable and explosive products. Economic losses caused by battery fires and explosions are countless every year, and the battery fire or explosion problem is solved in the market by using a heavy iron box, to achieve the fireproof and explosion-proof effects. Although this method can solve certain problems, it is inconvenient to carry the iron box due to the size and weight of the iron box and other problems, so that the iron box can only be placed in a place for long-term storage. As the batteries have been applied to everyone's daily life and the fire and explosion problem of the batteries cannot be solved in many cases, a fireproof, explosion-proof and heat-insulating storage bag is required to meet people's needs.

### SUMMARY

An objective of the present disclosure is to provide a fireproof, explosion-proof and heat-insulating storage bag, to solve the problems in the background that it is inconvenient to carry an iron box due to the size and weight of the iron box and other problems, so that the iron box can only be placed in a place for long-term storage, and as batteries have been applied to everyone's daily life, the fire and explosion problem of the batteries cannot be solved in many cases.

In order to achieve the above objective, the present disclosure provides the following technical solution: A fireproof, explosion-proof and heat-insulating storage bag, including a storage bag body, where the storage bag body is composed of a first fireproof fabric, a heat insulation material, an auxiliary molding material, and a second fireproof fabric; the first fireproof fabric and the second fireproof fabric are each made of one of a silicone rubber-coated glass fiber fabric, a fireproof basalt fiber fabric, a fireproof acrylic cotton fiber fabric, a fireproof Nomex fabric, a fireproof SM fabric, a fireproof blue glass fiber fabric, a fireproof aluminum foil fabric, a fireproof ceramic fabric, a fireproof high silica fabric, a fireproof silicon titanium fabric or another novel fireproof fabric, and the heat insulation material is made of a glass fiber, asbestos, rock wool, silicate, or another novel heat insulation material, such as aerogel felt or a vacuum board.

Preferably, the first fireproof fabric, the heat insulation material, the auxiliary molding material and the second fireproof fabric are integrated by using an impact molding process, and a fireproof edging braid is sewn at an edge.

Preferably, a zipper is sewn on the storage bag body.

The present disclosure has the following beneficial effects:

In the present disclosure, different specifications of models are formed by a fireproof and explosion-proof material, a heat insulation material and an auxiliary molding material; a plurality of materials are integrated to achieve fireproof, explosion-proof and heat-insulating functions, so that it is ensured that the product cannot be damaged within a certain period of time when placed on a fire source, and no spontaneous combustion occurs inside the storage bag. The fire source leakage is prevented, the fire source is prevented in the storage bag, and no fire is caused, thereby achieving the fireproof, explosion-proof and heat-insulating functions.

### BRIEF DESCRIPTION OF THE DRAWINGS

FIG. 1 is a schematic structural diagram of a fireproof, explosion-proof and heat-insulating storage bag according to the present disclosure; and

FIG. 2 is a schematic diagram of a layered structure of a fireproof, explosion-proof and heat-insulating storage bag according to the present disclosure.

In the drawings: 1. storage bag body, 2. fireproof edging braid; 3. zipper, 4. first fireproof fabric; 5. heat insulation material; 6. auxiliary molding material; 7. second fireproof fabric.

### DETAILED DESCRIPTION

The following clearly and completely describes the technical solutions in the embodiments of the present disclosure with reference to accompanying drawings in the embodiments of the present disclosure. Apparently, the described embodiments are merely some rather than all of the embodiments of the present disclosure.

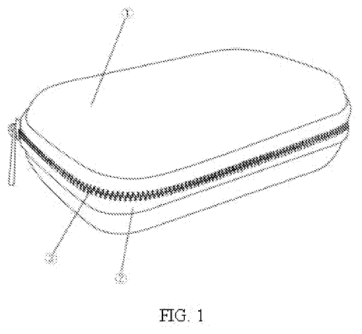

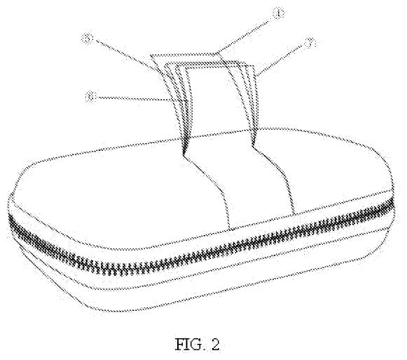

Referring to FIGS. 1-2, a fireproof, explosion-proof and heat-insulating storage bag, including a storage bag body 1, where the storage bag body 1 is composed of a first fireproof fabric 4, a heat insulation material 5, an auxiliary molding material 6, and a second fireproof fabric 7; the first fireproof fabric 4 and the second fireproof fabric 7 are each made of one of a silicone rubber-coated glass fiber fabric, a fireproof basalt fiber fabric, a fireproof acrylic cotton fiber fabric, a fireproof Nomex fabric, a fireproof SM fabric, a fireproof blue glass fiber fabric, a fireproof aluminum foil fabric, a fireproof ceramic fabric, a fireproof high silica fabric, a fireproof silicon titanium fabric or another novel fireproof fabric, and the heat insulation material 5 is made of a glass fiber, asbestos, rock wool, silicate, or another novel heat insulation material, such as aerogel felt or a vacuum board.

In the present disclosure, the first fireproof fabric 4, the heat insulation material 5, the auxiliary molding material 6 and the second fireproof fabric 7 are integrated by using an impact molding process, and a fireproof edging braid 2 is sewn at an edge.

In the present disclosure, a zipper 3 is sewn on the storage bag body 1.

The working principle of the present disclosure is as follows.

With regard to the structure process and packaging method of the storage bag body 1, a fireproof fabric, a heat insulation material, an auxiliary molding material and a fireproof fabric are used in structure process, and integrated by using an impact molding process, so that a seam area is reduced. After an upper cover and a lower cover are formed, seaming is performed by using a high-toughness fireproof wire in a mode of fireproof edging and a fireproof zipper (or a fireproof hook and loop fastener), so as to be integrated. With regard to the composite material synthesis: the composite material is composed of a first layer, namely a first fireproof fabric 4, a second layer, namely a heat insulation material 5, a third layer, namely an auxiliary molding material 6, and a fourth layer, namely a second fireproof fabric 7 (this can be based on the actual usage scenario requirements. If only external fire protection is required, the first layer is retained; if internal and external fire protection is required, the first layer and the fourth layer are retained; and if only internal fire protection is required, the fourth layer may be retained. The first layer of material may be replaced with another fitting material, the positions of the second layer and the third layer of materials may be changed. The fireproof fabric has a certain heat-insulating function. If strong heat insulation is required, the heat insulation layer is added, and if strong heat insulation is not required, the heat insulation layer is omitted). The composite material is molded by using a mold stamping process. After the composite material is molded, seaming is performed by using a fireproof edging braid 2 and the high-toughness fireproof wire to ensure the tight edging and the fireproof function. Sealing mode: seaming sealing is performed by using the high-toughness high-temperature-resistant fireproof zipper and the high-toughness fireproof wire in the direction of the fireproof edging. In order to ensure the fireproof performance and explosion-proof effect, metal zipper teeth may be used to achieve the fireproof and explosion-proof functions. If the zipper is not allowed to seal, sealing may be performed in a mode of a hook and loop fastener. The storage bag according to the present disclosure can be in direct contact with an open fire and has a certain explosion-proof and heat-insulating functions. When a battery spontaneously ignites and explodes, the fire source can be prevented from spreading, so that the fire that may occur is prevented from the beginning, thereby protecting personal safety and property safety. In addition, the storage bag is portable and small in size and may have many different appearances by using different mold shapes. Battery products stored internally are protected when a fire occurs externally, thereby preventing secondary accidents. Items stored inside the product can be protected from damage caused by high temperature and burning, thereby ensuring item safety.

The above descriptions are merely preferred specific embodiments of the present disclosure, but the protection scope of the present disclosure is not limited thereto. Equivalent replacements or changes made by any person skilled in the art in accordance with the technical solutions and conception of the present disclosure within the technical scope disclosed in the present disclosure should fall within the protection scope of the present disclosure.

1. A fireproof, explosion-proof and heat-insulating storage bag, comprising a storage bag body (1), wherein the storage bag body (1) is composed of a first fireproof fabric (4), a heat insulation material (5), an auxiliary molding material (6), and a second fireproof fabric (7); the first fireproof fabric (4) and the second fireproof fabric (7) are each made of one of a silicone rubber-coated glass fiber fabric, a fireproof basalt fiber fabric, a fireproof acrylic cotton fiber fabric, a fireproof Nomex fabric, a fireproof SM fabric, a fireproof blue glass fiber fabric, a fireproof aluminum foil fabric, a fireproof ceramic fabric, a fireproof high silica fabric, a fireproof silicon titanium fabric or another novel fireproof fabric, and the heat insulation material (5) is made of a glass fiber, asbestos, rock wool, silicate, or another novel heat insulation material, such as aerogel felt or a vacuum board.

2. The fireproof, explosion-proof and heat-insulating storage bag according to claim 1, wherein the first fireproof fabric (4), the heat insulation material (5), the auxiliary molding material (6) and the second fireproof fabric (7) are integrated by using an impact molding process, and a fireproof edging braid (2) is sewn at an edge.

3. The fireproof, explosion-proof and heat-insulating storage bag according to claim 1, wherein a zipper (3) is sewn on the storage bag body (1).
